(19) United States
(12) Patent Application Publication
(10) Pub. No.: US 2026/0254596 A1
(43) Pub. Date: Aug. 27, 2026

(54) MULTIPLE PHYSICAL UPLINK SHARED CHANNEL CONFIGURATIONS

(71) Applicant: LENOVO (BEIJING) LIMITED, Beijing (CN)

(72) Inventors: Chenxi Zhu, Fairfax, VA (US); Bingchao Liu, Beijing (CN); Yi Zhang, Beijing (CN); Wei Ling, Beijing (CN); Lingling Xiao, Beijing (CN)

(21) Appl. No.: 18/290,953

(22) PCT Filed: Jul. 22, 2021
(86) PCT No.: PCT/CN2021/107910

§ 371 Date: Jan. 22, 2024

(51) Int. Cl. H04L 5/00; H04W 72/231

(52) U.S. Cl. CPC H04L 5/0094; H04L 5/0098; H04W 72/231

(57) ABSTRACT

Apparatuses, methods, and systems are disclosed for multiple physical uplink shared channel configurations. One method (500) includes receiving (502) a radio resource control configuration message including a list of physical uplink shared channel configurations for a bandwidth part of a component carrier. Each physical uplink shared channel configuration of the list of physical uplink shared channel configurations has a physical uplink shared channel configuration identifier or is implicitly indicated and configures a set of parameters for a physical uplink shared channel. The method (500) includes receiving (504) an activation message that activates a physical uplink shared channel configuration of the list of physical uplink shared channel configurations. The method (500) includes applying (506) the activated physical uplink shared channel configuration.

### FIELD

The subject matter disclosed herein relates generally to wireless communications and more particularly relates to multiple physical uplink shared channel configurations.

### BACKGROUND

In certain wireless communications networks, changing physical uplink shared channel configurations may be inefficient. For example, changing physical uplink shared channel configurations may be done by transmission of a different physical uplink shared channel configuration using radio resource control signaling.

### BRIEF SUMMARY

Methods for multiple physical uplink shared channel configurations are disclosed. Apparatuses and systems also perform the functions of the methods. In one embodiment, the method includes receiving a radio resource control configuration message including a list of physical uplink shared channel configurations for a bandwidth part of a component carrier. Each physical uplink shared channel configuration of the list of physical uplink shared channel configurations has a physical uplink shared channel configuration identifier or is implicitly indicated and configures a set of parameters for a physical uplink shared channel. In various embodiments, the method includes receiving an activation message that activates a physical uplink shared channel configuration of the list of physical uplink shared channel configurations. In some embodiments, the method includes applying the activated physical uplink shared channel configuration.

An apparatus for multiple physical uplink shared channel configurations, in one embodiment, includes a receiver that: receives a radio resource control configuration message including a list of physical uplink shared channel configurations for a bandwidth part of a component carrier, wherein each physical uplink shared channel configuration of the list of physical uplink shared channel configurations has a physical uplink shared channel configuration identifier or is implicitly indicated and configures a set of parameters for a physical uplink shared channel; and receives an activation message that activates a physical uplink shared channel configuration of the list of physical uplink shared channel configurations. In some embodiments, the apparatus includes a processor that applies the activated physical uplink shared channel configuration.

In various embodiments, a method for multiple physical uplink shared channel configurations includes transmitting a radio resource control configuration message includes a list of physical uplink shared channel configurations for a bandwidth part of a component carrier. Each physical uplink shared channel configuration of the list of physical uplink shared channel configurations has a physical uplink shared channel configuration identifier or is implicitly indicated and configures a set of parameters for a physical uplink shared channel. In some embodiments, the method includes transmitting an activation message that activates a physical uplink shared channel configuration of the list of physical uplink shared channel configurations.

In some embodiments, an apparatus for multiple physical uplink shared channel configurations includes a transmitter that: transmits a radio resource control configuration message includes a list of physical uplink shared channel configurations for a bandwidth part of a component carrier, wherein each physical uplink shared channel configuration of the list of physical uplink shared channel configurations has a physical uplink shared channel configuration identifier or is implicitly indicated and configures a set of parameters for a physical uplink shared channel; and transmits an activation message that activates a physical uplink shared channel configuration of the list of physical uplink shared channel configurations.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for multiple physical uplink shared channel configurations;

FIG. 2 is a schematic block diagram illustrating one embodiment of an apparatus that may be used for multiple physical uplink shared channel configurations;

FIG. 3 is a schematic block diagram illustrating another embodiment of an apparatus that may be used for multiple physical uplink shared channel configurations;

FIG. 4 is a schematic block diagram illustrating one embodiment of a coverage area;

FIG. 5 is a schematic flow chart diagram illustrating one embodiment of a method for multiple physical uplink shared channel configurations; and

FIG. 6 is a schematic flow chart diagram illustrating another embodiment of a method for multiple physical uplink shared channel configurations.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

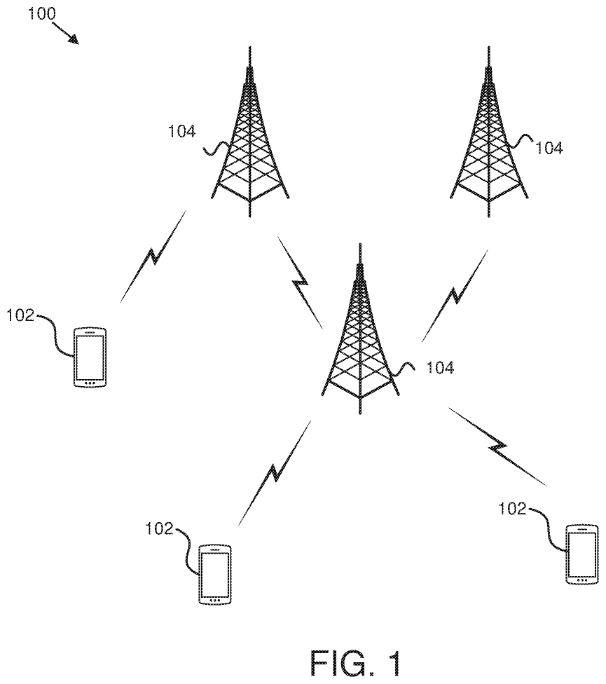

FIG. 1 depicts an embodiment of a wireless communication system 100 for multiple physical uplink shared channel configurations. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via uplink (“UL”) communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNodeB (“gNB”), a Home Node-B, a RAN, a relay node, a device, a network device, an integrated and access backhaul (“IAB”) node, a donor IAB node, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the third generation partnership program (“3GPP”) protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit downlink (“DL”) communication signals to serve the remote units 102 in the time, frequency, and/or spatial domain.

In various embodiments, a remote unit 102 may receive a radio resource control configuration message including a list of physical uplink shared channel configurations for a bandwidth part of a component carrier. Each physical uplink shared channel configuration of the list of physical uplink shared channel configurations has a physical uplink shared channel configuration identifier or is implicitly indicated and configures a set of parameters for a physical uplink shared channel. In various embodiments, the remote unit 102 may receive an activation message that activates a physical uplink shared channel configuration of the list of physical uplink shared channel configurations. In some embodiments, the remote unit 102 may apply the activated physical uplink shared channel configuration. Accordingly, a remote unit 102 may be used for multiple physical uplink shared channel configurations.

In some embodiments, a network unit 104 may transmit a radio resource control configuration message includes a list of physical uplink shared channel configurations for a bandwidth part of a component carrier. Each physical uplink shared channel configuration of the list of physical uplink shared channel configurations has a physical uplink shared channel configuration identifier or is implicitly indicated and configures a set of parameters for a physical uplink shared channel. In some embodiments, the network unit 104 may transmit an activation message that activates a physical uplink shared channel configuration of the list of physical uplink shared channel configurations. Accordingly, a network unit 104 may be used for multiple physical uplink shared channel configurations.

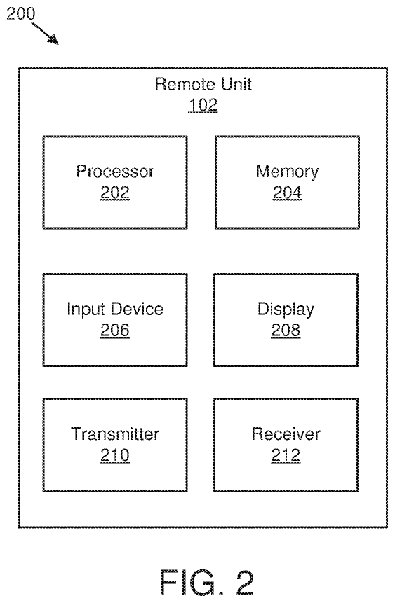

FIG. 2 depicts one embodiment of an apparatus 200 that may be used for multiple physical uplink shared channel configurations. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”) display, an LED display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In various embodiments, the receiver 212: receives a radio resource control configuration message including a list of physical uplink shared channel configurations for a bandwidth part of a component carrier, wherein each physical uplink shared channel configuration of the list of physical uplink shared channel configurations has a physical uplink shared channel configuration identifier or is implicitly indicated and configures a set of parameters for a physical uplink shared channel; and receives an activation message that activates a physical uplink shared channel configuration of the list of physical uplink shared channel configurations. In some embodiments, the processor 202 applies the activated physical uplink shared channel configuration.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

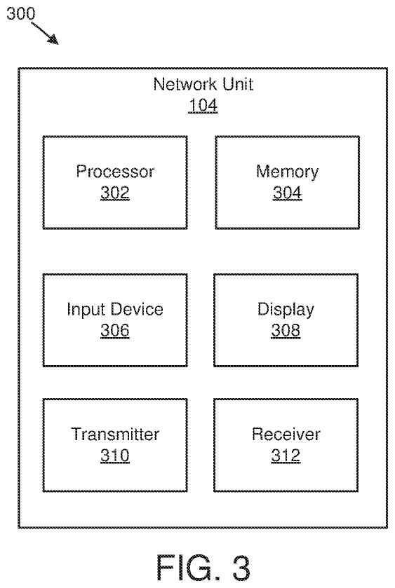

FIG. 3 depicts another embodiment of an apparatus 300 that may be used for multiple physical uplink shared channel configurations. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In various embodiments, the transmitter 310: transmits a radio resource control configuration message includes a list of physical uplink shared channel configurations for a bandwidth part of a component carrier, wherein each physical uplink shared channel configuration of the list of physical uplink shared channel configurations has a physical uplink shared channel configuration identifier or is implicitly indicated and configures a set of parameters for a physical uplink shared channel; and transmits an activation message that activates a physical uplink shared channel configuration of the list of physical uplink shared channel configurations.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In certain embodiments, physical uplink shared channel (“PUSCH”) may be considered the most complicated channel in new radio (“NR”). In some embodiments, PUSCH supports two different waveforms (e.g., cyclic prefix (“CP”) orthogonal frequency division multiplexing (“OFDM”) (“CP-OFDM”) and discreate Fourier transform (“DFT”) spread (“s”) OFDM (“DFT-s-OFDM”)), two different transmission modes (e.g., codebook based and non-WO codebook based), two different demodulation reference signals (“DMRSs”) (e.g., mapping type A and type B), two different frequency hopping modes (e.g., intra-slot and inter-slot), three different resource allocation types (e.g., type 0, type 1, dynamic switch), an aggregation factor (e.g., 1, 2, 4, 8), a modulation and coding scheme (“MCS”) table (e.g., quadrature amplitude modulation (“QAM”) 256 (“QAM256”), QAM 65 (“QAM65”)), a codebook subset based on coherent or partial and/or noncoherent, a maximum rank, a resource block group (“RBG”) size, and/or whether to support π/2 binary phase shift keying (“BPSK”). In various embodiments, PUSCH may be enhanced (e.g., for ultra-reliable low-latency communications (“URLLC”)), where two different PUSCH repetition patterns (e.g., repetition type A and B) are used with associated changes. In certain embodiments, new PUSCH features may be used to support multiple transmission and reception points (“TRPs”). In such embodiments, subband precoding, higher rank transmission, more DMRS ports, new codebooks, multiple user equipment (“UE”) panels and simultaneous uplink (“UL”) transmissions may be supported.

In some embodiments, different modes and different configurations may be changed with radio resource control (“RRC”) signals. In various embodiments, there is only 1 PUSCH-Config in RRC signaling for a UE in a certain common carrier (“CC”) and/or bandwidth part (“BWP”). If a network is to change a configuration (e.g., if the UE moves from cell-center to cell-edge and becomes limited by its transmission power and the gNB needs to ask the UE to transmit with DFT-s-OFDM instead of CP-OFDM waveform), the gNB may send a new PUSCH-Config message to the UE through RRC signaling to enable the change. In some complicated network deployments, the UE may need to frequently transition between different PUSCH transmission modes, such as between single TRP and multiple TRPs, between CP-OFDM and DFT-s-OFDM, between enhanced mobile broadband (“eMBB”) and URLLC, and between different repetition type and aggregation factors. It may be time-consuming to reconfigure using an RRC message each time and/or a latency of RRC reconfiguration may not support the dynamic switching.

In various embodiments, layer 1 (“L1”) and/or layer 2 (“L2”) handover may be focused on downlink (“DL”). In certain embodiments, L1/L2 handover may cover UL, including fast handover of PUSCH from a serving cell to a non-serving cell. In some embodiments, to handover a UE's UL traffic to a non-serving cell, a PUSCH-Config may need to be reconfigured by RRC signaling, including a data scrambling sequence identifier (“ID”) of a neighbor cell. This may incur significant delay.

In certain embodiments, a PUSCH with low latency may be used.

In some embodiments, a UE can be configured with more than one PUSCH configuration (e.g., PUSCH-Config) in a BWP. In such embodiments, a medium access control (“MAC”) control element (“CE”) (“MAC-CE”) message may be used to activate any of the PUSCH configurations for a UE to use in a BWP at any time.

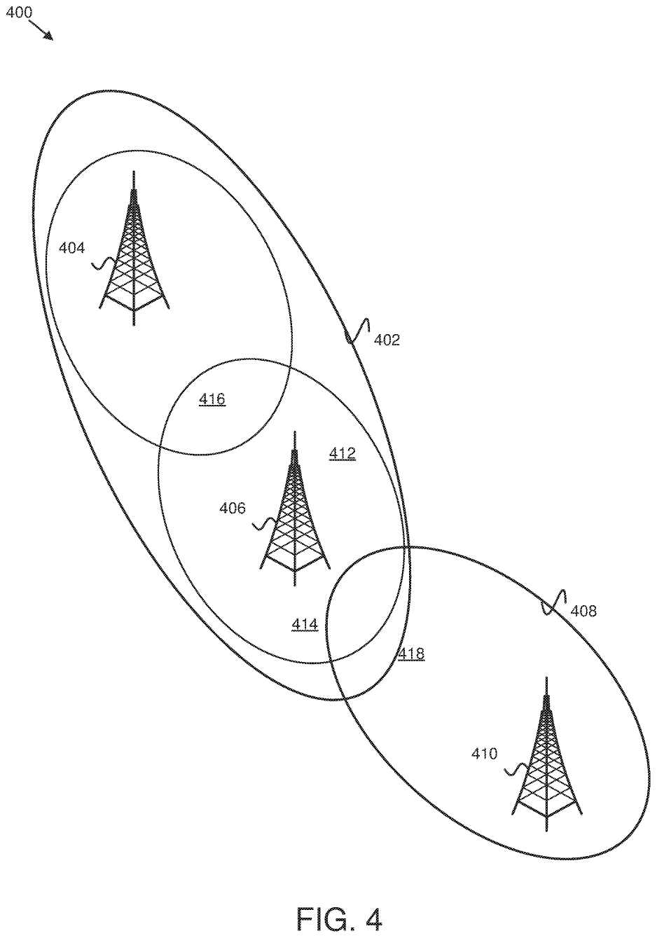

FIG. 4 is a schematic block diagram 400 illustrating one embodiment of a coverage area. In the example of FIG. 4, a coverage area with two cells and three TRPs is shown. In this example, cell 1 402 is served by TRP A 404 and TRP B 406, and cell 2 408 is served by TRP C 410. As the UE moves, from cell center to cell edge, from overlapping area of TRP A 404 and TRP B 406 to a non-overlapping area, or from cell 1 402 to cell 2 408, it may transmit with different modes of PUSCH. The gNB configures four PUSCH configurations (e.g., PUSCH-Config) for the UE as follows: 1) PUSCH-Config0 (Conf0) 412 is configured for single TRP transmission with CP-OFDM with the serving cell (cell 1 402); 2) PUSCH-Config1 (Conf1) 414 is configured for single TRP transmission with DFT-s-OFDM with the serving cell (cell 1 402); 3) PUSCH-Config2 (Conf2) 416 is configured for multi-TRP transmission with DFT-s-OFDM with the serving cell (cell 1 402); and 4) PUSCH-Config3 (Conf3) 418 is configured for single-TRP transmission with DFT-s-OFDM with the neighbor cell (cell 2 408). As the UE moves through different zones in the coverage areas, the network activates different PUSCH-Config with MAC-CE. The UE transmits the PUSCH with different configuration as illustrated in FIG. 4.

In various embodiments, to facilitate fast switching, all four configurations (e.g., four PUSCH-Config) may be configured in a UE. If a gNB needs the UE to use a new configuration (e.g., PUSCH-Config), the gNB activates that configuration (e.g., PUSCH-Config) using a MAC-CE message. The MAC-CE message may have a much shorter delivery latency due to its small size, and may become effective after 3 ms of the UE sending a hybrid automatic repeat request (“HARQ”) acknowledgement (“ACK”) (“HARQ-ACK”) for the physical downslink shared channel (“PDSCH”) carrying this MAC CE massage. This may result in a much shorter delay to switch to a new PUSCH configuration (e.g., PUSCH-Config) so the UL traffic does not experience a long delay during a radio resource control (“RRC”) reconfiguration as in configurations that do not use a MAC CE message to change a PUSCH configuration.

In certain embodiments, a new RRC parameter (e.g., PUSCH-ConfigurationList) may be used as part of an RRC configuration. The RRC parameter may include a list of PUSCH configurations (e.g., PUSCH-Config) for a UE and each configuration (e.g., PUSCH-Config) may have an identifier (“ID”) (e.g., PUSCH-Config-Id). Table 1 illustrates one embodiment of the RRC parameter.

TABLE 1
RRC Parameter (PUSCH-ConfigurationList)

-- ASN1START
-- TAG-PUSCH-CONFIG-List-START
PUSCH-ConfigurationList-r18 ::= SEQUENCE (SIZE
(1..MaxNumberOfPUSCHConfigurations)) OF PUSCH-Config
-- TAG-PUSCH-CONFIG-List-STOP
-- ASN1STOP

Each PUSCH configuration (e.g., PUSCH-Config) defines a particular configuration of PUSCH parameters. The value MaxNumberOfPUSCHConfiguration may be a maximum number of PUSCH configurations (e.g., PUSCH-Config) a UE can be configured with and is part of a UE capability signaled separately to a network. The network may not configure more than this limit to the UE at any time.

In one example, MaxNumberOfPUSCHConfiguration may be 2, 4, or another number. In the example of FIG. 4, MaxNumberOfPUSCHConfiguration=4, and PUSCH-Config-0 to PUSCH-Config-3 are included in that order. As may be appreciated, at any time, only one PUSCH configuration is activated by a MAC-CE message. Table 2 illustrates one embodiment of a MAC-CE message design having fields including reserved bits (“R”), a serving cell ID (e.g., occupying five bits), a BWP ID (e.g., occupying two bits), and a PUSCH-Config ID (e.g., occupying two bits).

TABLE 2
MAC-CE Message

| | | |
|---|---|---|
| R | Serving cell ID | BWP ID |

| | | | | | | |
|---|---|---|---|---|---|---|
| R | R | R | R | R | R | PUSCH- |

Config ID

In the embodiments illustrated in Table 2, an applied CC and BWP are indicated by the serving cell ID field and BWP ID field of the message. The field PUSCH-Config ID has a width of [log 2 (MaxNumberOfPUSCHConfiguration)] bits and indicates an activated PUSCH-Config the UE is to use. For example, it is set to 0b01 if PUSCH-Config-1 is activated.

Table 3 illustrates another embodiment of a MAC-CE message design having fields including reserved bits (“R”), a serving cell ID (e.g., occupying five bits), a BWP ID (e.g., occupying two bits), and a Cᵢ (e.g., occupying four bits).

TABLE 3
MAC-CE Message

| | | |
|---|---|---|
| R | Serving cell ID | BWP ID |

| | | | | | | | |
|---|---|---|---|---|---|---|---|
| R | R | R | R | C₃ | C₂ | C₁ | C₀ |

The bitmap Cᵢ of Table 3 is contained in the MAC CE to indicate the activated PUSCH-Config for the active BWP and the length of the bitmap is determined by MaxNumberOfPUSCHConfiguration. Cᵢ indicates an activation status of PUSCH-Config with PUSCH-Config-Id i. When Cᵢ is set to 1, the corresponding PUSCH-Config shall be used. Only one Cᵢ field can be set to ‘1’. For example, it is set to 0b0010 when PUSCH-Config1 is activated.

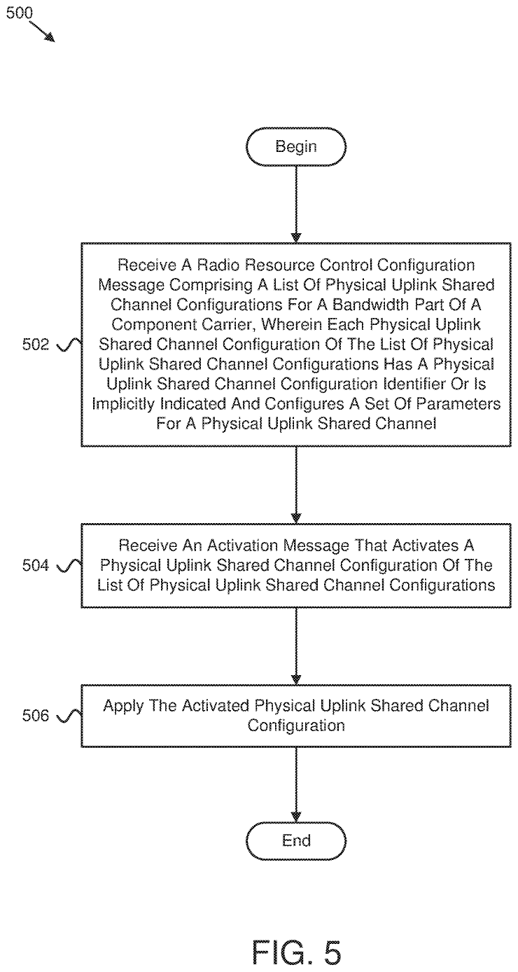

FIG. 5 is a schematic flow chart diagram illustrating one embodiment of a method 500 for multiple physical uplink shared channel configurations. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

The method 500 may include receiving 502 a radio resource control configuration message including a list of physical uplink shared channel configurations for a bandwidth part of a component carrier. Each physical uplink shared channel configuration of the list of physical uplink shared channel configurations has a physical uplink shared channel configuration identifier or is implicitly indicated and configures a set of parameters for a physical uplink shared channel. In various embodiments, the method 500 includes receiving 504 an activation message that activates a physical uplink shared channel configuration of the list of physical uplink shared channel configurations. In some embodiments, the method 500 includes applying 506 the activated physical uplink shared channel configuration.

In certain embodiments, receiving the activation message comprises receiving a medium access control control element activation message to activate the physical uplink shared channel configuration of the list of physical uplink shared channel configurations. In some embodiments, applying the activated physical uplink shared channel configuration comprises applying physical uplink shared channel configuration parameters of the activated physical uplink shared channel configuration for use in the physical uplink shared channel a predefined time after receiving the medium access control control element activation message.

In various embodiments, the medium access control control element activation message comprises a serving cell identifier, a bandwidth part identifier, and an identifier for the activated physical uplink shared channel configuration. In one embodiment, the medium access control control element activation message comprises a serving cell identifier, a bandwidth part identifier, and a bitmap to activate the physical uplink shared channel configuration, each bit of the bitmap indicates an activation status of a corresponding physical uplink shared channel configuration, and only one bit of the bitmap is set to 1. In certain embodiments, the method 500 further comprises reporting a capability parameter indicating a number of physical uplink shared channel configurations a user equipment is capable of handling for a bandwidth part.

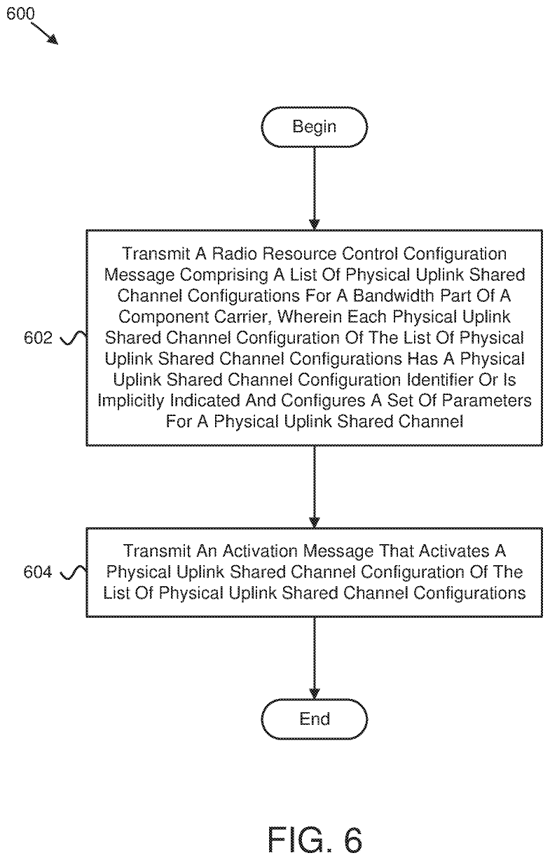

FIG. 6 is a schematic flow chart diagram illustrating another embodiment of a method 600 for multiple physical uplink shared channel configurations. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

The method 600 may include transmitting 602 a radio resource control configuration message includes a list of physical uplink shared channel configurations for a bandwidth part of a component carrier. Each physical uplink shared channel configuration of the list of physical uplink shared channel configurations has a physical uplink shared channel configuration identifier or is implicitly indicated and configures a set of parameters for a physical uplink shared channel. In some embodiments, the method 600 includes transmitting 604 an activation message that activates a physical uplink shared channel configuration of the list of physical uplink shared channel configurations.

In certain embodiments, transmitting the activation message comprises transmitting a medium access control control element activation message to activate the physical uplink shared channel configuration of the list of physical uplink shared channel configurations. In some embodiments, the medium access control control element activation message comprises a serving cell identifier, a bandwidth part identifier, and an identifier for the activated physical uplink shared channel configuration. In various embodiments, the medium access control control element activation message comprises a serving cell identifier, a bandwidth part identifier, and a bitmap to activate the physical uplink shared channel configuration, each bit of the bitmap indicates an activation status of a corresponding physical uplink shared channel configuration, and only one bit of the bitmap is set to 1.

In one embodiment, the method 600 further comprises configuring or scheduling a physical uplink shared channel transmission from a user equipment with parameters of the activated physical uplink shared channel configuration after a predefined time the medium access control control element activation message. In certain embodiments, a number of physical uplink shared channel configurations in the list of physical uplink shared channel configurations is no more than an upper limit. In some embodiments, the upper limit is part of user equipment capability received from the user equipment.

In one embodiment, a method comprises: receiving a radio resource control configuration message comprising a list of physical uplink shared channel configurations for a bandwidth part of a component carrier, wherein each physical uplink shared channel configuration of the list of physical uplink shared channel configurations has a physical uplink shared channel configuration identifier or is implicitly indicated and configures a set of parameters for a physical uplink shared channel; receiving an activation message that activates a physical uplink shared channel configuration of the list of physical uplink shared channel configurations; and applying the activated physical uplink shared channel configuration.

In certain embodiments, receiving the activation message comprises receiving a medium access control control element activation message to activate the physical uplink shared channel configuration of the list of physical uplink shared channel configurations.

In some embodiments, applying the activated physical uplink shared channel configuration comprises applying physical uplink shared channel configuration parameters of the activated physical uplink shared channel configuration for use in the physical uplink shared channel a predefined time after receiving the medium access control control element activation message.

In various embodiments, the medium access control control element activation message comprises a serving cell identifier, a bandwidth part identifier, and an identifier for the activated physical uplink shared channel configuration.

In one embodiment, the medium access control control element activation message comprises a serving cell identifier, a bandwidth part identifier, and a bitmap to activate the physical uplink shared channel configuration, each bit of the bitmap indicates an activation status of a corresponding physical uplink shared channel configuration, and only one bit of the bitmap is set to 1.

In certain embodiments, the method further comprises reporting a capability parameter indicating a number of physical uplink shared channel configurations a user equipment is capable of handling for a bandwidth part.

In one embodiment, an apparatus comprises: a receiver that: receives a radio resource control configuration message comprising a list of physical uplink shared channel configurations for a bandwidth part of a component carrier, wherein each physical uplink shared channel configuration of the list of physical uplink shared channel configurations has a physical uplink shared channel configuration identifier or is implicitly indicated and configures a set of parameters for a physical uplink shared channel; and receives an activation message that activates a physical uplink shared channel configuration of the list of physical uplink shared channel configurations; and a processor that applies the activated physical uplink shared channel configuration.

In certain embodiments, the receiver receiving the activation message comprises the receiver receiving a medium access control control element activation message to activate the physical uplink shared channel configuration of the list of physical uplink shared channel configurations.

In some embodiments, the processor applying the activated physical uplink shared channel configuration comprises the processor applying physical uplink shared channel configuration parameters of the activated physical uplink shared channel configuration for use in the physical uplink shared channel a predefined time after receiving the medium access control control element activation message.

In various embodiments, the medium access control control element activation message comprises a serving cell identifier, a bandwidth part identifier, and an identifier for the activated physical uplink shared channel configuration.

In one embodiment, the medium access control control element activation message comprises a serving cell identifier, a bandwidth part identifier, and a bitmap to activate the physical uplink shared channel configuration, each bit of the bitmap indicates an activation status of a corresponding physical uplink shared channel configuration, and only one bit of the bitmap is set to 1.

In certain embodiments, the apparatus further comprises a transmitter that reports a capability parameter indicating a number of physical uplink shared channel configurations a user equipment is capable of handling for a bandwidth part.

In one embodiment, a method comprises: transmitting a radio resource control configuration message comprising a list of physical uplink shared channel configurations for a bandwidth part of a component carrier, wherein each physical uplink shared channel configuration of the list of physical uplink shared channel configurations has a physical uplink shared channel configuration identifier or is implicitly indicated and configures a set of parameters for a physical uplink shared channel; and transmitting an activation message that activates a physical uplink shared channel configuration of the list of physical uplink shared channel configurations.

In certain embodiments, transmitting the activation message comprises transmitting a medium access control control element activation message to activate the physical uplink shared channel configuration of the list of physical uplink shared channel configurations.

In some embodiments, the medium access control control element activation message comprises a serving cell identifier, a bandwidth part identifier, and an identifier for the activated physical uplink shared channel configuration.

In various embodiments, the medium access control control element activation message comprises a serving cell identifier, a bandwidth part identifier, and a bitmap to activate the physical uplink shared channel configuration, each bit of the bitmap indicates an activation status of a corresponding physical uplink shared channel configuration, and only one bit of the bitmap is set to 1.

In one embodiment, the method further comprises configuring or scheduling a physical uplink shared channel transmission from a user equipment with parameters of the activated physical uplink shared channel configuration after a predefined time the medium access control control element activation message.

In certain embodiments, a number of physical uplink shared channel configurations in the list of physical uplink shared channel configurations is no more than an upper limit.

In some embodiments, the upper limit is part of user equipment capability received from the user equipment.

In one embodiment, an apparatus comprises: a transmitter that: transmits a radio resource control configuration message comprising a list of physical uplink shared channel configurations for a bandwidth part of a component carrier, wherein each physical uplink shared channel configuration of the list of physical uplink shared channel configurations has a physical uplink shared channel configuration identifier or is implicitly indicated and configures a set of parameters for a physical uplink shared channel; and transmits an activation message that activates a physical uplink shared channel configuration of the list of physical uplink shared channel configurations.

In certain embodiments, the transmitter transmitting the activation message comprises the transmitter transmitting a medium access control control element activation message to activate the physical uplink shared channel configuration of the list of physical uplink shared channel configurations.

In some embodiments, the medium access control control element activation message comprises a serving cell identifier, a bandwidth part identifier, and an identifier for the activated physical uplink shared channel configuration.

In various embodiments, the medium access control control element activation message comprises a serving cell identifier, a bandwidth part identifier, and a bitmap to activate the physical uplink shared channel configuration, each bit of the bitmap indicates an activation status of a corresponding physical uplink shared channel configuration, and only one bit of the bitmap is set to 1.

In one embodiment, the apparatus further comprises a processor that configures or schedules a physical uplink shared channel transmission from a user equipment with parameters of the activated physical uplink shared channel configuration after a predefined time the medium access control control element activation message.

In certain embodiments, a number of physical uplink shared channel configurations in the list of physical uplink shared channel configurations is no more than an upper limit.

In some embodiments, the upper limit is part of user equipment capability received from the user equipment.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a radio resource control (RCC) configuration message comprising a list of physical uplink shared channel (PUSCH) configurations for a bandwidth part of a component carrier, wherein each PUSCH configuration of the list of PUSCH configurations has a PUSCH configuration identifier (ID) or is implicitly indicated and configures a set of parameters for a PUSCH;
receive an activation message that activates a PUSCH configuration of the list of PUSCH configurations; and
apply the activated PUSCH configuration.

2. The UE of claim 1, wherein the at least one processor is configured to cause the UE to receive the activation message comprises receiving a medium access control control element (MAC CE) activation message to activate the PUSCH configuration of the list of PUSCH configurations.

3. The UE of claim 2, wherein the at least one processor is configured to cause the UE to apply the activated PUSCH configuration comprises applying PUSCH configuration parameters of the activated PUSCH configuration for use in the PUSCH a predefined time after receiving the medium access control MAC control element CE activation message.

4. The UE of claim 2, wherein the MAC CE activation message comprises a serving cell ID, a bandwidth part ID, and an ID for the activated PUSCH configuration.

5. The UE of claim 2, wherein the MAC CE activation message comprises a serving cell ID, a bandwidth part ID, and a bitmap to activate the PUSCH configuration, each bit of the bitmap indicates an activation status of a corresponding PUSCH configuration, and only one bit of the bitmap is set to 1.

6. The UE of claim 1, wherein the at least one processor is configured to cause the UE to report a capability parameter indicating a number of PUSCH configurations a UE is capable of handling for a bandwidth part.

7. An apparatus A processor for wireless communication, comprising:
at least one controller coupled with at least one memory and configured to cause the processor to:
receive a radio resource control (RCC) configuration message comprising a list of physical uplink shared channel (PUSCH) configurations for a bandwidth part of a component carrier, wherein each PUSCH configuration of the list of PUSCH configurations has a PUSCH configuration identifier (ID) or is implicitly indicated and configures a set of parameters for a PUSCH;
receive an activation message that activates a PUSCH configuration of the list of PUSCH configurations; and
apply the activated PUSCH configuration.

8. A method performed by a base station, the method comprising:
transmitting a radio resource control (RCC) configuration message comprising a list of physical uplink shared channel (PUSCH) configurations for a bandwidth part of a component carrier, wherein each PUSCH configuration of the list of PUSCH configurations has a PUSCH configuration identifier (ID) or is implicitly indicated and configures a set of parameters for a PUSCH; and
transmitting an activation message that activates a PUSCH configuration of the list of PUSCH configurations.

9. The method of claim 8, wherein transmitting the activation message comprises transmitting a medium access control control element (MAC CE) activation message to activate the PUSCH configuration of the list of PUSCH configurations.

10. The method of claim 9, wherein the MAC CE activation message comprises a serving cell ID, a bandwidth part ID, and an ID for the activated PUSCH configuration.

11. The method of claim 9, wherein the MAC CE activation message comprises a serving cell ID, a bandwidth part ID, and a bitmap to activate the PUSCH configuration, each bit of the bitmap indicates an activation status of a corresponding PUSCH configuration, and only one bit of the bitmap is set to 1.

12. The method of claim 9, further comprising configuring or scheduling a PUSCH transmission from a UE with parameters of the activated PUSCH configuration after a predefined time the MAC CE activation message.

13. The method of claim 8, wherein a number of PUSCH configurations in the list of PUSCH configurations is no more than an upper limit.

14. The method of claim 13, wherein the upper limit is part of UE capability received from the UE.

15. An apparatus A base station, comprising:
at least one memory; and
at least one processor coupled with the at least one memory and configured to cause the base station to:
transmit a radio resource control (RCC) configuration message comprising a list of physical uplink shared channel (PUSCH) configurations for a bandwidth part of a component carrier, wherein each PUSCH configuration of the list of PUSCH configurations has a PUSCH configuration identifier (ID) or is implicitly indicated and configures a set of parameters for a PUSCH; and
transmit an activation message that activates a PUSCH configuration of the list of PUSCH configurations.

16. The base station of claim 15, wherein the at least one processor is configured to cause the base station to transmit the activation message by transmitting a MAC CE activation message to activate the PUSCH configuration of the list of PUSCH configurations.

17. The base station of claim 16, wherein the MAC CE activation message comprises a serving cell ID, a bandwidth part ID, and an ID for the activated PUSCH configuration.

18. The base station of claim 16, wherein the MAC CE activation message comprises a serving cell ID, a bandwidth part ID, and a bitmap to activate the PUSCH configuration, each bit of the bitmap indicates an activation status of a corresponding PUSCH configuration, and only one bit of the bitmap is set to 1.

19. The base station of claim 16, wherein the at least one processor is configured to cause the base station to configure or schedule a PUSCH transmission from a UE with parameters of the activated PUSCH configuration after a predefined time the MAC CE activation message.

20. The base station of claim 15, wherein a number of PUSCH configurations in the list of PUSCH configurations is no more than an upper limit.
